(19) United States
(12) Patent Application Publication
(10) Pub. No.: US 2023/0106245 A1
(43) Pub. Date: Apr. 6, 2023

(54) METHOD AND DEVICE FOR VULCANIZING TIRES

(71) Applicant: HARBURG-FREUDENBERGER MASCHINENBAU GMBH, Hamburg (DE)

(72) Inventors: Stefan BAHLKE, Lüneburg (DE); Andreas STÖHRMANN, St. Peter-Ording (DE)

(21) Appl. No.: 17/795,956

(22) PCT Filed: Jan. 12, 2021
(86) PCT No.: PCT/DE2021/100027

§ 371 Date: Jul. 28, 2022

(30) Foreign Application Priority Data
Jan. 30, 2020 (DE) 10 2020 102 299.9

(51) Int. Cl. B29D 30/00; B29D 30/06

(52) U.S. Cl. CPC B29D 30/0016; B29D 30/0601; B29D 2030/0022; B29D 2030/0027

(57) ABSTRACT

A method and a device for vulcanizing tires. The device and method allow a small width and an inexpensive construction of the device in particular by virtue of the special design of or the material flow produced by the device and method. The device has at least one vulcanization chamber and at least one unloader for unloading an at least partially vulcanized tire out of the vulcanization chamber. The device additionally has at least one depositing device, at least one sliding device, and a transport belt for transporting the tire away.

The invention concerns a device for vulcanizing tires in the sense of a tire heating press.

The invention also concerns a method for vulcanizing tires.

The production of tires, for example for vehicles such as cars, trucks or motorcycles, is an extremely complex process which comprises a plurality of manufacturing and processing steps. The reason is the complex tire construction, which consists of a substantial number of different individual components. In addition, this plurality of components must be bonded together under the action of temperature and heat, known as vulcanization. The vulcanization process is also decisive for the material and adhesion properties of the finished tire.

Not only the finished tire, as the end product of the tire manufacturing process, but also the tire blank is a highly complex component made of many semifinished elements. Because of the multi-ply structure, the individual components must first be joined together before the vulcanization process, i.e. the tire components are separated out according to size, and supplied in the correct attitude, position and orientation to at least one tire construction drum situated inside the tire construction machine. In this way, the tire blank is produced and prepared for vulcanization.

Many of the tire components are present in the form of webs and/or sheets of semifinished products; various rubber mixtures and rubber-based composite materials, woven textiles or textile cords, woven steel belts and rubber-encased bead cores. Ply servers inside the tire construction machine are sometimes used to supply these webs and/or sheets of semifinished products to the carcass drum.

Because of the substantial number of production steps, production sites are implemented in large halls and comprise suitable machines, equipment and handling gear for the individual production steps. These production lines or production centers are supplemented by prestream and downstream equipment for preparation of tire components or aftertreatment or packing of the finished tires.

One frequently necessary aftertreatment process following vulcanization may take the form of targeted cooling of the finished tire, which still contains residual heat, optionally under internal pressurization. Since the finished tire with its residual heat is structurally unstable and very delicate, particularly high requirements apply to the handling devices for removing the tire from the vulcanization chamber of the tire vulcanizing machine, and transporting or placing it in the aftertreatment device. Therefore, handling devices are equipped with suitable gripper tools which can also grip and receive the delicate tires. Gripper tools of this design are complex and expensive.

Handling devices, which are also known as loaders or unloaders because of their function within the tire production process and in relation to the handling space of the tire vulcanizing machine, must move the tire or tire blank to be handled over distances in all spatial directions, and in some cases alter the tire orientation.

Furthermore, movements and orientation changes must be carried out as quickly as possible in order to keep the necessary handling and transport times short and minimize the total process time of tire production.

Such devices are known for example from DE 10 2016 006 518 A1.

The prior art furthermore discloses methods and devices by means of which tire blanks can be loaded by means of a first handling device, configured as a loading device, into the vulcanization chamber of a tire heating press, wherein they can be vulcanized into tires in the vulcanization chamber of the tire heating press, and after vulcanization can be removed from the vulcanization chamber of the tire heating press by means of a second handling device, configured as an unloading device.

Furthermore, DE 10 2016 007 465 A1 also discloses supplying the tire after vulcanization to an aftertreatment device, configured for example as a post-curing inflator (PCI).

Such devices for vulcanizing tires may be configured for example as tire heating presses for tires of cars, trucks or motorcycles.

Because of the above-described complexity and the size of the products to be produced, such equipment usually takes up a large amount of space, so production halls for tires must be correspondingly large.

It is an object of the invention to indicate a device for vulcanizing tires which requires less space.

This object is achieved according to the invention by a device for vulcanizing tires as claimed in claim 1.

It is a further object of the invention to indicate an improved device for vulcanizing tires.

This object is achieved according to the invention by a device for vulcanizing tires as claimed in claim 1.

A further object of the invention is to provide a method for vulcanizing tires which supports a smaller size of the device used for vulcanizing tires.

This object is achieved according to the invention by a method for vulcanizing tires as claimed in claim 10.

A further object of the invention is to provide an improved method for vulcanizing tires.

This object is achieved according to the invention by a method for vulcanizing tires as claimed in claim 10.

The subclaims disclose advantageous embodiments of the method and device according to the invention.

The features disclosed below of a method for vulcanizing tires form part of the invention both individually and in all implementable combinations.

In a method according to the invention for vulcanizing tires, in a method step, a tire blank is loaded into a vulcanization chamber of a tire heating press. In a further step, the tire blank is vulcanized or at least partially vulcanized in the vulcanization chamber of the tire heating press. In a further method step, the vulcanized or at least partially vulcanized tire is unloaded from the vulcanization chamber of the tire heating press. In a method step after vulcanization of the tire, the tire is deposited on a depositing apparatus. As soon as the tire is ready to be transported away, and/or must be transported away according to the predefined production cycle, it is moved onto a conveyor belt and transported away by the conveyor belt.

In a preferred embodiment of the method for vulcanizing tires according to the invention, in a further method step, after the at least partial vulcanization in the vulcanization chamber, the tire is supplied to an aftertreatment device. After aftertreatment of the tire in the aftertreatment device, the tire is then deposited on the depositing apparatus.

The depositing apparatus is therefore used as an intermediate store for fully vulcanized tires.

In an embodiment of a method for vulcanizing tires according to the invention, the device for discharging the vulcanized tire from the vulcanization chamber or the aftertreatment device is used as an intermediate store for at least partially vulcanized tires before these are deposited on the depositing apparatus.

In a preferred embodiment of a method for vulcanizing tires according to the invention, this is configured as a method for vulcanizing tires by means of a double heating press. The double heating press here comprises two vulcanization chambers for vulcanizing tires, and two aftertreatment devices.

In various embodiments of a method for vulcanizing tires according to the invention with a double heating press, the method steps disclosed above are applied accordingly.

In an embodiment of the method according to the invention for vulcanizing tires by means of a double heating press, a common loader is used for both vulcanization chambers which loads the vulcanization chambers alternately.

In another embodiment of the method for vulcanizing tires according to the invention, the vulcanization chambers of the double heating press are each loaded by means of an individually assigned loader.

In an embodiment of the method for vulcanizing tires according to the invention, the loaders of the vulcanization chambers are actuated in parallel so that the vulcanization chambers are loaded in parallel.

In an embodiment of the method according to the invention for vulcanizing tires by means of a double heating press, a common unloader is used for both vulcanization chambers which unloads the vulcanization chambers alternately.

In a particularly preferred embodiment of the method according to the invention for vulcanizing tires by means of a double heating press, the tires which are at least partially vulcanized in the respective vulcanization chamber are loaded into the respective assigned aftertreatment device and unloaded from the respective aftertreatment device, after completion of aftertreatment, by means of the common unloader.

In another embodiment of the method according to the invention for vulcanizing tires by means of a double heating press, an individually assigned unloader is used for each vulcanization chamber, by means of which the vulcanization chambers are unloaded in parallel.

In another embodiment of the method according to the invention for vulcanizing tires by means of a double heating press, an individually assigned unloader is used for each vulcanization chamber, by means of which the vulcanization chambers are unloaded independently of one another.

In a preferred embodiment of the method according to the invention for vulcanizing tires by means of a double heating press, using unloaders individually assigned to each vulcanization chamber, the tires which are at least partially vulcanized in the respective vulcanization chambers are loaded into the respective assigned aftertreatment device and unloaded from the respective aftertreatment device, after completion of the aftertreatment, by means of the respective assigned unloader.

In an advantageous embodiment of the method according to the invention for vulcanizing tires by means of a double heating press, after completion of the aftertreatment in the respective aftertreatment device, the tires are deposited at the depositing point of the respective assigned depositing apparatus.

In an embodiment of the method according to the invention for vulcanizing tires by means of a double heating press, as soon as transport away should or can take place, the tires are pushed from the depositing point of the respective depositing apparatus onto a transport belt by means of a sliding device and transported away.

In a preferred embodiment of the method according to the invention for vulcanizing tires by means of a double heating press, the tires which have been vulcanized by means of both vulcanization chambers and any aftertreatment devices are transported away on a common transport belt.

In an embodiment of the method for vulcanizing tires according to the invention, the tires are fully vulcanized and/or cooled under control by means of the respective aftertreatment device.

In a preferred embodiment of the method for vulcanizing tires according to the invention, in addition to heating and/or cooling, the tires are also internally pressurized by means of the respective aftertreatment device during aftertreatment.

In a particularly preferred embodiment of a method for vulcanizing tires according to the invention, the tire blanks—or in the later course of production, the at least partially vulcanized tires—are moved onto curved tracks by means of the corresponding handling devices such as loaders and unloaders.

Because of the movement of the tire blanks or the at least partially vulcanized tires on curved tracks, they can be moved around structural elements of the device for vulcanizing tires, so that a more compact construction becomes possible.

The features disclosed below of a device for vulcanizing tires form part of the invention both individually and in all implementable combinations.

A device for vulcanizing tires is configured as a tire heating press and has at least one vulcanization chamber for vulcanizing tires.

Furthermore, a device according to the invention comprises at least one loader for loading tire blanks into the at least one vulcanization chamber.

Furthermore, a device according to the invention for vulcanizing tires comprises at least one unloader for unloading the at least partially vulcanized tire from the at least one vulcanization chamber.

Also, in an advantageous embodiment, a device for vulcanizing tires according to the invention comprises at least one aftertreatment device by means of which the at least partially vulcanized tires can be aftertreated.

In an embodiment of the invention, the at least one aftertreatment device comprises an isolating hood or an isolating chamber, and/or an internal heater, and/or a device for internally pressurizing a tire with compressed air, and/or a cooling device for controlled cooling of a tire.

In a preferred embodiment, the at least one aftertreatment device is configured as a multiple aftertreatment device in which simultaneous aftertreatment of at least two at least partially vulcanized tires is possible in one aftertreatment unit per tire.

In one embodiment of the invention, the at least one aftertreatment device comprises at least two aftertreatment units which are arranged one above the other in a preferred embodiment.

In one embodiment, a device according to the invention for vulcanizing tires comprises at least one depositing apparatus on which a tire can be deposited.

In one embodiment of the invention, the at least one depositing apparatus is configured as a substantially flat surface.

In a preferred embodiment of the invention, the at least one depositing apparatus is arranged between the vulcanization chamber and the aftertreatment device.

In one embodiment of the invention, the device for vulcanizing tires according to the invention is configured as a double heating press which comprises a first vulcanization chamber and a second vulcanization chamber.

In an advantageous embodiment, a double heating press according to the invention comprises a loader which is configured for alternate loading of the first and second vulcanization chambers.

In a further embodiment of a double heating press according to the invention, this comprises two loaders, wherein each loader is assigned to a vulcanization chamber.

In a preferred embodiment of the invention with two loaders, these are each mounted in the region of the outer sides of the vulcanization chambers so as to be rotatable about a respective axis.

In an embodiment of the invention with two loaders, these can be actuated in parallel so that the vulcanization chambers can be loaded in parallel.

In a further embodiment of the invention with two loaders, these can be actuated independently of one another so that the vulcanization chambers can be loaded independently of one another.

Furthermore, in an advantageous embodiment, a double heating press according to the invention comprises an unloader which is configured for alternate unloading of the first and second vulcanization chambers.

In a further embodiment of a double heating press according to the invention, this comprises two unloaders which are each assigned to a vulcanization chamber.

In an embodiment of a double heating press according to the invention with two unloaders, the unloaders can be actuated in parallel so that the vulcanization chambers can be unloaded in parallel.

In a further embodiment of a double heating press according to the invention with two unloaders, the unloaders can be actuated independently of one another so that the vulcanization chambers can be unloaded independently of one another.

In an embodiment of a double heating press according to the invention with two unloaders, these are each mounted in a centrally arranged region of the vulcanization chambers so as to be rotatable about at least one axis.

In a preferred embodiment of a device for vulcanizing tires according to the invention, configured as a double heating press, this comprises a first aftertreatment device assigned to the first vulcanization chamber and a first depositing apparatus assigned to the first aftertreatment device. Furthermore, in this preferred embodiment, the double heating press according to the invention comprises a second aftertreatment device assigned to the second vulcanization chamber and a second depositing apparatus assigned to the second aftertreatment device.

In an advantageous embodiment of a device for vulcanizing tires according to the invention, configured as a double heating press, the at least one unloader is configured to unload the at least partially vulcanized tire from a vulcanization chamber and then load it into the respective assigned aftertreatment device.

In a particularly advantageous embodiment of the invention, the at least one unloader is furthermore configured to unload the aftertreated tire from the aftertreatment device and deposit this on the respective assigned depositing apparatus.

In an embodiment of the device for vulcanizing tires according to the invention, this comprises a transport belt for transporting away the aftertreated or fully vulcanized tires.

In a preferred embodiment of the device for vulcanizing tires according to the invention, this comprises precisely one transport belt for transporting away the aftertreated or fully vulcanized tires.

In an embodiment of the device for vulcanizing tires according to the invention, this comprises at least one sliding device by means of which a tire deposited on a depositing apparatus can be pushed onto the transport belt.

In an embodiment of the device for vulcanizing tires according to the invention, a sliding device is assigned to each depositing apparatus.

In one embodiment of the invention, a sliding device comprises at least one controllable cylinder and a slider attached to the free end of the cylinder piston, which contacts the tire during pushing of the tire onto the transport belt.

In a preferred embodiment of a tire heating press according to the invention, because of the structure of the tire heating press resulting from the special arrangement of the assemblies, a width of only around 3 m is possible.

In an embodiment of the invention, the device for vulcanizing tires is configured as a double heating press for truck tires.

Exemplary embodiments of devices and methods for vulcanizing tires according to the invention are illustrated in the figures which follow. The drawings show:

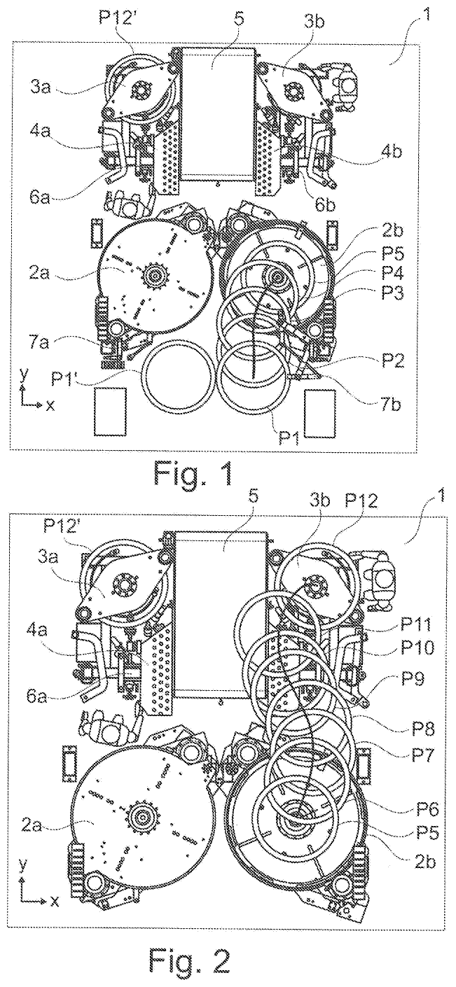

FIG. 1: a schematic illustration of an embodiment of a device for vulcanizing tires according to the invention, in a view from above, with indicated positions of the tire blank during loading of a vulcanization chamber,

FIG. 2: a schematic illustration of the embodiment shown in FIG. 1 of a device for vulcanizing tires according to the invention, in a view from above, with indicated positions of the tire during unloading of a vulcanization chamber and loading of an aftertreatment device,

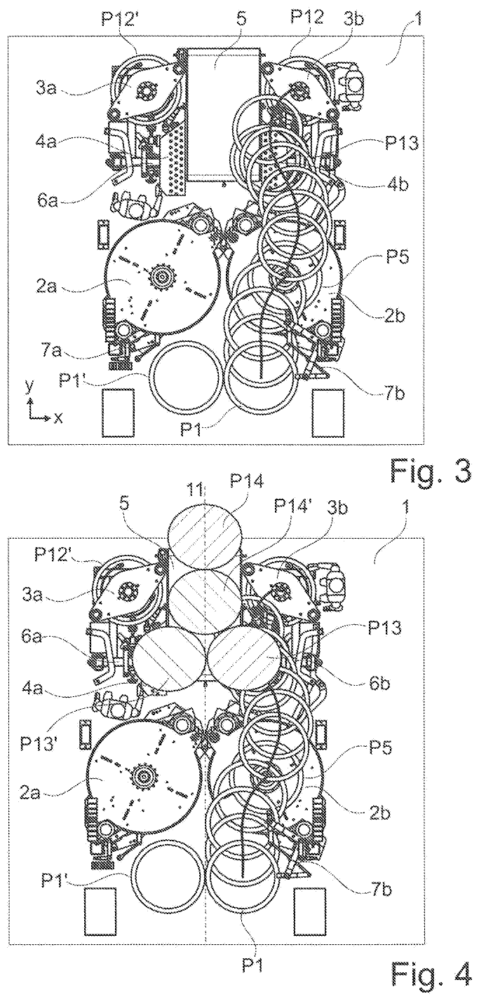

FIG. 3: a schematic illustration of the embodiment shown in FIGS. 1 and 2 of a device for vulcanizing tires according to the invention, in a view from above, with indicated positions of the tire blank/tire from loading of a vulcanization chamber up to loading of an aftertreatment device, and

FIG. 4: the illustration from FIG. 3 with additional positions of the tire in the region of the device for vulcanizing tires following the aftertreatment.

FIG. 1 shows a schematic illustration of an embodiment of a device according to the invention for vulcanizing tires (1), configured as a double heating press, in a view from above. The figure does not show, inter alia, the at least one unloading device of the double heating press.

The device for vulcanizing tires (1) comprises a first vulcanization chamber (2a) and a second vulcanization chamber (2b), a first aftertreatment device (3a) and a second aftertreatment device (3b), a first depositing apparatus (4a) and a second depositing apparatus (4b), and a transport belt (5).

The device for vulcanizing tires (1) furthermore comprises a loader (7) which is configured as two loaders (7a, 7b) which are each assigned to a vulcanization chamber (2a, 2b).

A sliding device (6a, 6b) is arranged in the region of the deposit apparatus (4a, 4b), by means of which a tire can be pushed from the respective depositing apparatus (4a, 4b) onto the centrally arranged transport belt (5).

The figure also shows the positions P1 to P5 (indicated by circles) of the tire blank, processed on the right-hand side of the double heating press, during loading of the second vulcanization chamber (2b) by means of the assigned loader (7b), and the indicated positions P1′ of a tire blank, to be processed on the left-hand side, before the first vulcanization chamber (2a), and P12′ of a tire in the first aftertreatment device (3a).

During loading of the second vulcanization chamber (2b) by means of the assigned loader (7b), the center of the tire blank moves approximately along the dotted line with a slight curve. During loading of the first vulcanization chamber (2a) by means of the assigned loader (7a), the tire blank moves along a corresponding line, mirror-symmetrically about the longitudinal axis of the device for vulcanizing tires (1).

FIG. 2 shows the embodiment shown in FIG. 1 of the device for vulcanizing tires (1) according to the invention, in a view from above, with positions P5 to P12 (indicated by circles) of the at least partially vulcanized tire during unloading of the second vulcanization chamber (2b) and during loading of the second aftertreatment device (3b).

Preferably, the second vulcanization chamber (2b) is unloaded and the second aftertreatment device (3b) loaded in one process.

For this, in one embodiment of the invention, the unloader (not shown in this figure) is configured both for unloading the second vulcanization chamber (2b) and also for loading the second aftertreatment device (3b).

Particularly preferably, the unloader is configured for alternate unloading of both vulcanization chambers (2a, 2b) and for loading the respective assigned aftertreatment device (3a, 3b) with the respective, at least partially vulcanized tire.

In another embodiment of the invention, an individual unloader is assigned to each vulcanization chamber (2a, 2b).

The center of the at least partially vulcanized tire moves approximately along the dotted line between positions P5 and P12. The line curves in two opposing directions. The line curves firstly to the right and then to the left.

For a tire produced on the side of the first vulcanization chamber (2a) and the first aftertreatment device (3a), the movement of the tire is an approximate mirror image about the longitudinal axis of the device for vulcanizing tires (1).

FIG. 3 shows a schematic illustration of the embodiment shown in FIGS. 1 and 2 of a device for vulcanizing tires (1) according to the invention, in a view from above, with positions P1 to P12 (indicated by circles) of the tire blank/tire from loading of the second vulcanization chamber (2b) up to loading of the second aftertreatment device (3b), and position P13 of the tire on the second depositing apparatus (4b) onto which the tire is placed following aftertreatment in the second aftertreatment device (3b).

The dotted line indicates the approximate track of the movement of the center of the tire blank or the at least partially vulcanized tire from loading of the second vulcanization chamber (2b) up to loading of the second aftertreatment device (3b). The line has three curves, wherein this curves initially to the left, then to the right, and then back again to the left.

The approximate track of the movement of the center of a tire produced on the side of the first vulcanization chamber (2a) and the first aftertreatment device (3a) is a corresponding mirror image about the longitudinal axis of the device for vulcanizing tires (1).

FIG. 4 shows the illustration from FIG. 3 with additionally highlighted positions P13 and P13′ of the tire in the region of the device vulcanizing tires (1), following the aftertreatment, on the respective depositing apparatus (4a, 4b), and the positions P14 and P14′ on the transport belt (5). Also, the longitudinal axis M of the device for vulcanizing tires (1) is marked.

1-15. (canceled)

16. A device for vulcanizing tires, comprising: at least one vulcanization chamber; at least one loader for loading a tire blank into the at least one vulcanization chamber; at least one unloader for unloading an at least partially vulcanized tire from the at least one vulcanization chamber; at least one depositing apparatus; at least one sliding device; and a conveyor belt, wherein the at least one unloader is configured to unload a tire from the at least one vulcanization chamber and deposit the tire on the at least one depositing apparatus, and wherein the at least one sliding device is configured to push the tire deposited on the depositing apparatus onto the conveyor belt for transporting the tire away.

17. The device for vulcanizing tires according to claim 16, further comprising at least one aftertreatment device for aftertreatment of an at least partially vulcanized tire.

18. The device for vulcanizing tires according to claim 16, wherein the device is a double heating press comprising a first vulcanization chamber and a second vulcanization chamber.

19. The device for vulcanizing tires according to claim 18, further comprising a first aftertreatment device assigned to the first vulcanization chamber and a first depositing apparatus assigned to the first aftertreatment device, and a second aftertreatment device assigned to the second vulcanization chamber and a second depositing apparatus assigned to the second aftertreatment device.

20. The device for vulcanizing tires according to claim 19, wherein the at least one sliding device includes an individual sliding device assigned to each depositing apparatus.

21. The device for vulcanizing tires according to claim 18, wherein the double heating press is configured for truck tires.

22. The device for vulcanizing tires according to claim 16, wherein the device for vulcanizing tires has a width of approximately 3.0 m to 3.1 m.

23. The device for vulcanizing tires according to claim 18, including a first loader assigned to the first vulcanization chamber, and a second loader assigned to the second vulcanization chamber.

24. The device for vulcanizing tires according to claim 23, wherein the first loader and the second loader are configured to be actuatable in parallel so that the vulcanization chambers are loaded in parallel.

25. A method for vulcanizing tires, comprising the steps of: loading a tire blank into a vulcanization chamber of a device for vulcanizing tires using a loader; at least partially vulcanizing the tire blank in the vulcanization chamber; unloading the at least partially vulcanized tire from the vulcanization chamber using an unloader; depositing the at least partially vulcanized tire on a depositing apparatus; pushing the at least partially vulcanized tire onto a transport belt by a sliding device; and transporting the at least partially vulcanized tire away by the transport belt.

26. The method for vulcanizing tires according to claim 25, including, after vulcanization in the vulcanization chamber, loading the at least partially vulcanized tire into an aftertreatment device for aftertreatment, and, following the aftertreatment in the aftertreatment device, depositing the tire on the depositing apparatus.

27. The method for vulcanizing tires according to claim 25, wherein the device for vulcanizing tires is a double heating press having a first vulcanization chamber and a second vulcanization chamber, the method including loading and unloading the vulcanization chambers in parallel or alternately.

28. The method for vulcanizing tires according to claim 27, wherein a first loader loads the first vulcanization chamber, and a second loader loads the second vulcanization chamber with tire blanks, and a first unloader unloads the at least partially vulcanized tire from the first vulcanization chamber, and a second unloader unloads the at least partially vulcanized tire from the second vulcanization chamber.

29. The method for vulcanizing tires according to claim 28, wherein the respective unloader performs both the loading of the at least partially vulcanized tire into an assigned aftertreatment device and the unloading of aftertreated tire from the aftertreatment device.
